(19) United States
(12) Patent Application Publication
(10) Pub. No.: US 2026/0175631 A1
(43) Pub. Date: Jun. 25, 2026

(54) Device for Securing an Electronic Member to a Tire Casing

(71) Applicant: COMPAGNIE GENERALE DES ETABLISSEMENTS MICHELIN, Cler,pmt-Ferrand (FR)

(72) Inventors: Loic BERLIOUX, Clermont-Ferrand cedex 9 (FR); Francis CARTERON, Clermont-Ferrand cedex 9 (FR)

(21) Appl. No.: 19/127,723

(22) PCT Filed: Nov. 15, 2023
(86) PCT No.: PCT/EP2023/081845

§ 371 Date: May 6, 2025

(30) Foreign Application Priority Data
Nov. 25, 2022 (FR) FR2212333

(51) Int. Cl. B60C 23/04; B60C 19/00; B60C 19/12; B60C 25/14

(52) U.S. Cl. CPC B60C 23/0493; B60C 19/00; B60C 19/002; B60C 19/12; B60C 25/145

(57) ABSTRACT

A device (10) for securing an electronic member to a wall of a tire, having a base (11) secured to the wall of the tire via an external surface (15) and a retaining wall (12). The retaining wall (12) extends from the base (11) as far as a free edge (13) and defines an open volume (20) with the base (11). The volume (20), which is able to accommodate at least a part of the electronic member, has an opening (16) delimited by the free edge (13) of the retaining wall (12), which is able to deform for the insertion or extraction of the electronic member into or from the volume (20). The external surface (15) of the base (11) has an array of recessed elements (101, 201) and protruding elements (102, 202) defining a maximum variation in height of between 10 μm and 200 μm.

### FIELD OF THE INVENTION

The present invention relates to devices for securing an electronic member to a tire casing with the aim of conveying identification information on the tire casing or physical parameters of the tire casing that are measured by the electronic member over the course of the life of the tire casing.

### TECHNOLOGICAL BACKGROUND

The development of electronic objects in tire casings makes it possible to make tire casings connectable and connected, and this stimulates the development of new services in order to optimize the use of the tire casing, for example. Now, these electronic members sometimes have thermomechanically fragile components, and this requires the electronic member to be inserted after manufacture of the tire casing. Thus, the insertion of a securing device as interface between the electronic member and the tire has emerged. These securing devices are generally elastic so as not to highly stress the tire casing, so as to follow the substantial deformations undergone by the tire casing over the course of its use and so as to damp the stresses transmitted to the electronic member. One of the most commonly used designs for the device is a patch having a base used for securing to the tire casing and provided with a wall that is closed on itself and extends from the base as far as an opening. The wall serves to hold or keep the electronic member in position within the device, the electronic member being mounted tightly inside the wall that deforms elastically. The opening allows the insertion and extraction of the electronic member into and from the patch by virtue of the elasticity of the material of the opening.

Document WO2018/150141A1 illustrates a patch of this nature. Although this patch specifically has a clamping system in order to limit the opening, it is at any point in accordance with a patch for securing an electronic object to a tire casing. In addition, this type of patch sometimes presents a problem of mechanical strength of the system comprising the patch and the electronic member over the course of the use of the tire casing to which this system is secured, in particular when the patch, with or without electronics, is secured to the tire after curing of the tire casing via a connecting adhesive.

The aim of the following subjects of the invention is to solve the problems of mechanical endurance of the securing patch that is simultaneously economical, reliable and without impact on the operation of the electronic member accommodated within the securing patch.

### DESCRIPTION OF THE INVENTION

The invention relates to a device for securing an electronic member to a wall of a tire casing, comprising:
a base that is able to be secured to the wall of the tire casing via an external surface;
a closed retaining wall, which is able to retain said electronic member, extending from the base as far as a free edge and defining an open volume with said base;
the volume, which is able to accommodate at least a part of said electronic member, being defined by an internal surface of said base and by said retaining wall, having an opening delimited by the free edge of said retaining wall, which is able to deform for the insertion or extraction of said electronic member into or from said volume;
the external surface of said base comprising a homogenous array of recessed elements and protruding elements defining a maximum variation in height of between 10 μm and 200 μm; and
   the securing device is characterized in that the arrangement of the array of the recessed elements and protruding elements is concentric about a single point of the external surface of the base or in the form of a chequerboard of which the pairwise adjacent tiles are a recessed element and a protruding element.

The securing device has, via the array of recessed elements and protruding elements, a volume that will act as reserve for accommodating a product of adhesive type at the moment at which this device is secured to the wall of the tire casing. The term “homogenous” is understood here to mean that the recessed elements and protruding elements are distributed uniformly on the external surface of the base. Thus, the uniform distribution is ensured of the reserve of adhesive that will be applied to the external surface of the base at the moment at which the latter is secured to the internal wall of the tire. Even though contact is made directly between the external surface of the base and the internal wall of the tire casing, the array ensures, at the recessed elements, the presence of adhesive between the external surface of the base and the internal wall of the tire casing. By ensuring a minimum height between the bottom of the base and a bearing plane of the base, a certain thickness of adhesive is ensured through all of the array, uniformly distributed on the entire external surface of the base, and this makes it possible to control this average thickness of adhesive. Depending on the nature of the adhesive and the mode of breaking of the securing that is desired, the array makes it possible to place the desired thickness under control. Specifically, the breaking of the securing is either breaking at the interface between, on the one hand, the adhesive and, on the other hand, one of the elements among the base and the internal wall of the tire casing. This breaking of the securing can also be the decohesion of the internal structure of the adhesive itself, depending on the type of stresses undergone by the adhesive. This decohesion of the structure of the adhesive is controlled, for certain products, by the thickness of the film of adhesive. Thus, during the operation of adhesively bonding the securing device to the internal wall of the tire casing, the array of recessed elements and protruding elements ensures the place, the nature of the breaking and the threshold from which the breaking is carried out.

In a first embodiment of the homogenous array, the array is constructed by protruding elements that are regularly spaced apart from one another radially by a recess. These elements are cylindrical shapes that are concentric about one and the same point of the external surface along an axis perpendicular to the external surface of the base. These cylindrical elements have, for example, a section of circle or ellipse type. This embodiment of the homogenous array of recesses is well suited to production via moulding of the securing device, although other processes may be used. Specifically, it is sufficient to create, on the die of the mould defining the external surface of the base, the imprint of the concentric homogenous array so that the latter is created at the same time as the manufacture of the securing device. This has the advantage of making the protruding elements of the array integral with the base of the securing device. In addition, the final device with its homogenous array is easy to remove from the mould as a result of the concentricity of these elements, even as regards the external groove. In addition, the moulding process ensures that the homogenous array is repeatable, for a lower manufacturing cost. However, this technique is designed for a residual voids volume at the securing device that is quite high, and this is perfectly well suited to certain types of adhesive.

In a second embodiment of the homogenous array, the array comprises a chequerboard of which the boxes correspond alternately to a protruding element and a recessed element. Preferentially, this chequerboard is defined in two orthogonal directions, but it is sufficient for the two directions to make an angle of 30 degrees with one another for this to be able to be sufficiently effective, in particular for the cleaning of the surface before coating thereof.

This chequerboard is advantageously created after the manufacture of the securing patch, which is generally obtained via a moulding process. It may be a question of a chemical process after application of an activating agent through a stencil positioned on the external surface of the base. Applying a reactant to all of the external surface of the base then places the chequerboard predefined by the shape of the stencil in relief. It may also be a question of a mechanical process in which a brush with regularly spaced rows of rigid bristles is rubbed in two well-controlled directions on the external surface of the base. After the step of creating the chequerboard, the external surface of the base should be cleaned in order to eliminate the residues of material and to make the external surface of the base chemically inert before the application of the adhesive. Finally, it may be a question of a heat treatment via a laser of which the beam describes a succession of straight lines spaced apart from one another by a certain distance constituting the width of the groove elements. The passage of the laser in two intersecting directions then generates a homogenous chequerboard of recessed boxes and protruding boxes. The latter process makes it possible to create recesses with small dimensions in terms of both depth and width.

Advantageously, the width of the recessed elements between two protruding elements is between 500 μm and 1500 μm.

Outside of the overall volume of adhesive that can be distributed homogenously at the external surface of the base, it is also necessary to ensure, at each pad of adhesive, that the breaking mode is controlled so as not to cause progressive breaking of the overall securing of the base by weakening encountered by a few pads causing a transfer of stress to the other pads leading to the ruining of the overall securing of the base to the internal wall of the tire casing.

Now, the mechanical strength of this pad is controlled, on the one hand by the average variation in height between the bottom of the recessed elements and the top of the protruding elements, and on the other hand by the distance separating two protruding elements, which corresponds to the width of the recessed element. By controlling this second parameter, it is ensured that the dimensioning of each pad of adhesive is satisfactory for ensuring the mechanical strength of the pad individually. Depending on the nature of the adhesive used for securing the securing device to the internal wall of the tire casing and the type of breaking desired for this securing, the required width may change.

Very advantageously, the contour of the external surface of the base comprises a protrusion of which the height is less than or equal to the maximum height of the protruding elements of the homogenous array of the external surface of the base.

The presence of this protrusion located on the contour of the external surface of the base serves to prevent the adhesive from escaping via this location in the absence of the protrusion on the outside of the external surface of the base. Thus, it is ensured that the quantity of adhesive placed on the external surface of the base will indeed remain below the base although the internal wall of the tire casing has a concave shape. As a result, this protrusion ensures the overall volume of adhesive present beneath the base. Specifically, if the coating of the external surface of the base is greater than that which is recommended, the average volume of adhesive will extend beyond the height of the protrusion, and this will then let the surplus escape during the operation of adhesive bonding of the securing device to the internal wall of the tire. In addition, this protrusion, during the phase of coating the securing device, allows mechanical control of the quantity of adhesive deposited on the homogenous array of recessed elements and protruding elements by scraping the deposited adhesive using a straight tool that can bear on the external surface of the protrusion.

Specifically, the protrusion on the contour of the external surface has a width of less than 500 μm.

Even though the external surface of this protrusion, which is proportional to the width of the protrusion, does not contain adhesive, or not enough to ensure secure adhesion of the protrusion to the internal wall of the tire casing, the dimension of the array remains sufficient to ensure the mechanical strength of the securing device with respect to the tire casing.

Specifically, since the arrangement of the array of the recessed elements and protruding elements is concentric, the voids volume defined by the array is between 30 mm³ and 120 mm³.

Advantageously, the external surface of the base comprises at least 3 protruding elements.

Advantageously, since the arrangement of the array of the recessed elements and protruding elements is in the form of a chequerboard, the voids volume defined by the array is between 1 mm³ and 10 mm^{3.}

The invention also relates to an arrangement of a tire casing comprising a crown (S), two sidewalls (F) extending from the crown (S) and terminating in two beads (B) that are able to be connected to a wheel, and of a securing device, wherein the securing device is secured to one of the surfaces of the tire casing, preferentially to the wall situated furthest towards the inside of the tire casing.

The arrangement of the tire casing and the securing device is the purpose of the securing device by nature. In this case, in order to preserve the electronic member intended to be inserted into the securing device, it is preferable that the securing device is situated inside the fluidic cavity delimited by the internal wall of the tire casing and the wheel rim on which the tire casing is mounted.

Advantageously, the securing device is secured in line with the crown (S) of the tire casing, preferentially beneath a groove situated towards the outside of the vehicle when the tire casing is mounted on a transport vehicle.

For functionalities for measuring the deformation of the tire casing that may be observed on the signals from various sensors of the electronic member intended to be inserted into the securing device, it is more advantageous that the securing device and as a result the associated electronic member are situated in line with the crown (S) of the tire casing. For example, a signal from an impact sensor or accelerometer in the radial direction makes it possible to detect the contact patch in which the tire casing is in contact with the ground. The information associated with the length of the contact patch make it possible to estimate the static load borne by the tire casing and also its instantaneous rotational speed. The promoted adhesion of the securing device with the internal wall of the tire casing qualitatively, or even quantitatively, enhances the estimation of these parameters of the tire casing by improving the sensitivity of the sensitive sensors of the electronic member accommodated within the securing device.

Very advantageously, the part of the wall situated furthest towards the inside of the tire casing that has to accommodate the securing device comprises an array of recessed elements and protruding elements comprising a maximum variation in height of between 10 μm and 100 μm.

Constituting a first homogenous array of recessed elements and protruding elements at the external surface of the base ensures a certain quantity of adhesive at the interface between the external surface of the base and the internal wall of the tire casing. However, in the case in which the volume of adhesive thus constituted is not sufficient to ensure the mechanical strength of each pad of adhesive corresponding to a recessed element, it may be envisaged to add to this individual volume a second homogenous array of recessed elements and protruding elements at the wall of the tire casing. In addition, statistically, this second homogenous array may create connection pads between the two components at the protruding elements of the external surface of the base, and this makes the film of adhesive between the two elements more uniform despite the presence of the two homogenous arrays.

Preferentially, this second homogenous array is effected following a step of stripping the internal wall of the tire casing in line with the zone for accommodating the securing device. This makes it possible to optimize the surface state of the internal wall of the tire casing before the securing of the securing device. In addition, advantageously, the second homogenous array is not the inverse image of the first homogenous array of the external surface of the base. If the first homogenous array is concentric, it is advisable for the second array to rather be a chequerboard. Likewise, if the first array is a chequerboard, it is advisable for the second homogenous array to be a chequerboard of which each of the two directions is not coincident with one of the directions of the first chequerboard.

Advantageously, the securing device is secured via an adhesive contained in the group comprising cyanoacrylates and silanes.

For elastomeric materials of the tire casing having a relatively airtight internal wall, these adhesives may be used since they have a mechanical strength compatible with these said materials for these thermomechanical stresses conventionally undergone by a tire casing in service.

The invention also relates to an arrangement of a tire casing and of a securing device secured to the internal wall of the tire casing, wherein an electronic member is inserted into the securing device of the arrangement.

Preferentially, the tire casing of the arrangement is mounted on a wheel, preferentially in an inflated state.

This is the ultimate purpose of the securing device, i.e. accommodating an electronic member when this device is secured to the internal wall of a tire casing. Specifically, the improved securing ensured by the specific structure of the securing device at the external surface of the base ensures a signal level that can be exploited at the sensors of the electronic member, making it possible to derive information intrinsic to the tire casing in operation without being excessively disturbed by the presence of the securing device.

### BRIEF DESCRIPTION OF THE DRAWINGS

The invention will be better understood upon reading the following description, given solely by way of non-limiting example and with reference to the appended figures, throughout which the same reference numerals denote identical parts, and in which:

FIG. 1 shows a perspective view of a device for securing an electronic member to a tire;

FIG. 2 shows a bottom view and a side view of one and the same securing device according a first embodiment of the invention;

FIG. 3 shows a bottom view of a securing device in a second embodiment of the invention;

FIG. 4 shows a perspective view in cross section of a tire casing equipped with a securing device according to the invention.

### DETAILED DESCRIPTION OF EMBODIMENTS

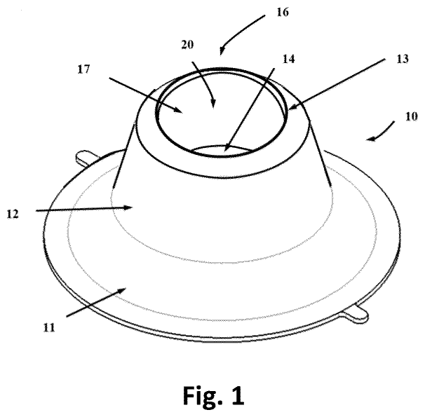

FIG. 1 is a perspective view of a prior art device 10 for securing an electronic member to a tire casing. The securing device 10 is in this case of the open type, i.e. the electronic member is inserted into or extracted from the securing device via an orifice that is accessible even when the securing device 10 is secured to the tire casing. As a result, the operations for inserting or extracting the electronic member into or from the securing device 10 may take place directly on the tire casing.

This securing device 10 has a base 11 of which the function of the external surface is to be secured to the surface of a tire casing using prior art technical solutions well known to those skilled in the art. The securing device 10 in this case exhibits symmetry of revolution about an axis of rotation perpendicular to the base 11. A retaining wall 12, which is closed over 360 degrees, adjoins this base 11. This retaining wall 12 has an opening 16 delimited by a free edge 13 of the retaining wall 12 of the securing device 10. The orifice 16 opens onto an open volume 20 delimited by the internal surface 14 of the base 11 and the internal surface 17 of the retaining wall 12. The orifice 16 is deformable so as to allow the insertion and extraction of an electronic member into and from the open volume 20. The elastic property of the material of this retaining wall 12 authorizes this enlargement of the orifice 16 for the insertion and extraction phases. In addition, it also ensures a retaining or clamping force on the electronic member when the latter is housed in the open volume 20.

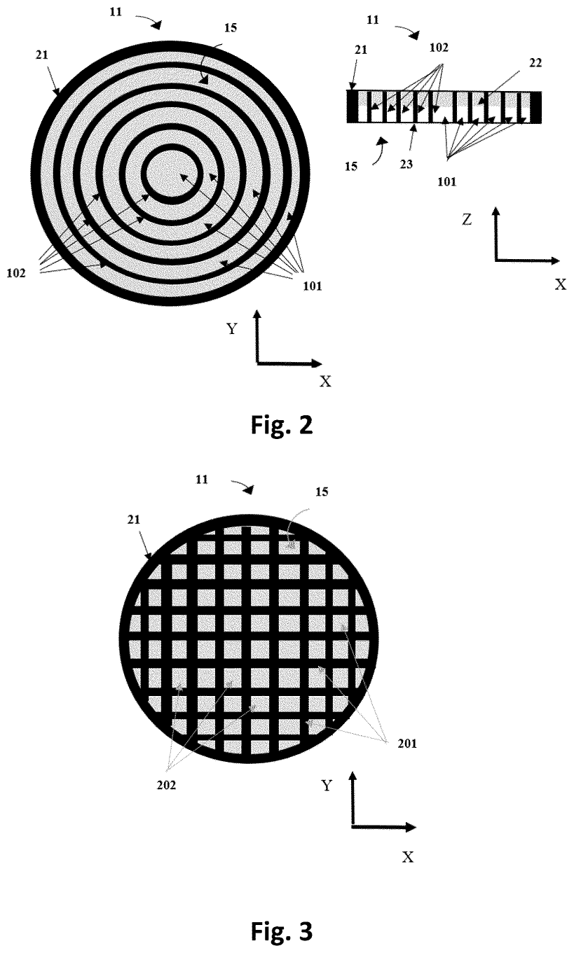

FIG. 2 shows the array of protruding elements and recessed elements of the external surface 15 of the base 11.

This array is in the form of concentric elements about a central point of the external surface 15 of the base 11. This forms an array that is homogenous by nature, in which the voids volume is evenly distributed angularly and radially about this central point. The higher the number of alternations between recessed elements 101 and protruding elements 102, the more uniformly the distribution of recesses on the external surface 15 of the base 11 is distributed. In this case, the elements, both the protruding elements 102 and the recessed elements 101, have dimensions that are identical to one another, according to their type, in terms of width and height. In order to improve the homogeneity of the distribution of adhesive through the array, the width of the recesses 101 may change depending on the radial distance of the recessed element 101 with respect to the central point.

The outer contour of the external surface 15 of the base 11 is constituted of a protrusion 21 of which the height is less than or equal to the maximum height 23 of the protruding elements 102 with respect to the depth 22 of the recessed elements 101. Thus, this protrusion 21 constitutes a barrier delimiting the adhesive at the external surface 15 of the base 11. This ensures that the adhesive present between the external surface 15 of the base 11 and the internal wall of the tire will not exceed a certain volume. In addition, by controlling the quantity of adhesive applied to the external surface 15 of the base 11, the volume of adhesive for the connection of the securing device 10 to the tire is then controlled. Depending on the type of adhesive used for securing the device to the wall of the tire casing and the nature of the desired breaking of the connection, it is possible to adjust the depth of the recessed elements 101 so as to obtain the correct type of breaking both in terms of location and in terms of threshold for triggering the breaking.

FIG. 3 shows the array of protruding elements and recessed elements of the external surface 15 of the base 11 according to a second embodiment.

This array is in the form of a chequerboard consisting of an alternation of recessed boxes 201 and protruding boxes 202 of the external surface 15 of the base 11. This forms an array that is homogenous by nature, in which the voids volume is evenly distributed on the external surface 15 of the base. In this case, the elements, both the protruding elements 202 and the recessed elements 201, have dimensions that are identical in terms of peripheral dimension. In order to improve the homogeneity of the distribution of adhesive through the array, the intrinsic dimension of the boxes should then be reduced, and this ensures greater fineness of distribution of the adhesive at the boxes. In this case, the chequerboard is obtained using the passage in two perpendicular directions of a metal object at the external surface 15 of the base 11 for a substantial recess depth. For lesser depths, a heat treatment of the external surface 15 of the base using a laser ray following a rectilinear scan of the laser with respect to the external surface 15 may be envisaged. It is then sufficient to define two orthogonal scanning directions of the laser, in order to obtain the orthogonal chequerboard. A step of cleaning the external surface 15 of the base is recommended before the application of the adhesive. Of course, it is possible to constitute a chequerboard of diamonds instead of rectangles. However, it is preferable that the angle formed by the two directions of the chequerboard makes an angle of at least 30 degrees so as to ensure effective cleaning in the most acute angles of the diamond.

The outer contour of the external surface 15 of the base 11 is constituted of a protrusion 21 of which the height is less than or equal to the maximum height 23 of the protruding elements 202 with respect to the depth 22 of the recessed elements 201. Thus, this protrusion 21 constitutes a barrier delimiting the adhesive at the external surface 15 of the base 11. This ensures that the adhesive present between the external surface 15 of the base 11 and the internal wall of the tire does not exceed a certain volume. In addition, by controlling the quantity of adhesive applied to the external surface 15 of the base 11, the volume of adhesive for the connection of the securing device 10 to the tire is then controlled. Depending on the type of adhesive used for securing the device to the wall of the tire casing and the nature of the desired breaking of the connection, it is possible to adjust the depth of the recessed elements 201 so as to obtain the correct type of breaking both in terms of location and in terms of threshold for triggering the breaking.

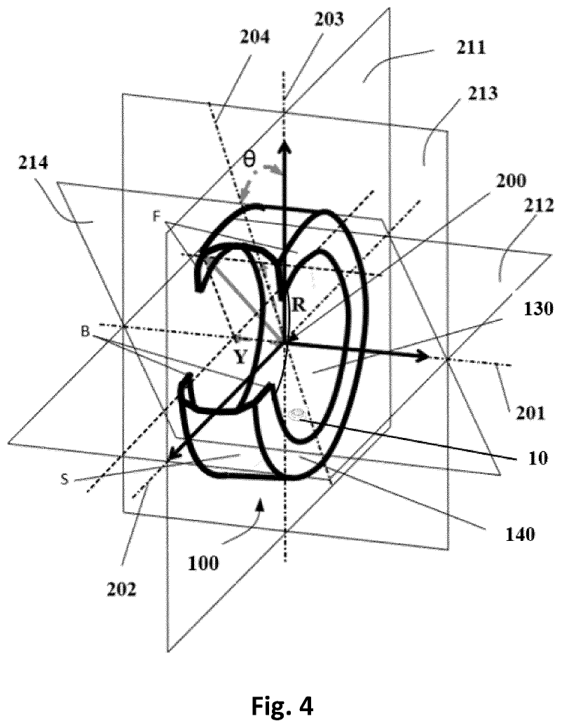

FIG. 4 shows a cross section of a pneumatic tire 100, which is also a tire casing, according to the invention, comprising a crown S extended by two sidewalls F and terminating in two beads B. In this case, the tire 100 is intended to be mounted on a wheel that is not shown in this figure, at the two beads B. A closed cavity containing at least one pressurized fluid is thus delimited, which is delimited both by the second, radially inner surface 130 of the pneumatic tire 100 and by the external surface of the wheel. The pneumatic tire 100 also comprises a first, radially external surface 140 of the pneumatic tire 100.

The reference axis 201 corresponding to the reference axis or natural axis of rotation of the pneumatic tire 100, and the median plane 211, which is perpendicular to the reference axis 201 and equidistant from the two beads B, will be noted. The intersection of the reference axis 201 with the median plane 211 determines the centre of the pneumatic tire 200. A Cartesian frame of reference will be defined at the centre of the pneumatic tire 200, constituted of the reference axis 201, a vertical axis 203 perpendicular to the ground and a longitudinal axis 202 perpendicular to the other two axes. Furthermore, an axial plane 212 is defined that passes through the reference axis 201 and the longitudinal axis 202, parallel to the plane of the ground and perpendicular to the median plane 211. Finally, the plane perpendicular to both the median plane 211 and the axial plane 212, passing through the vertical axis 203, is called the vertical plane 213.

Any material point of the pneumatic tire 100 is uniquely defined by its cylindrical coordinates (Y, R, θ). The scalar Y represents the axial distance to the centre of the pneumatic tire 200 in the direction of the reference axis 201, defined by the orthogonal projection of the material point of the tire 100 on the reference axis 201. A radial plane 214 making an angle θ with respect to the vertical plane 213 around the reference axis 201 will be defined. The material point of the pneumatic tire 100 is referenced in this radial plane 214 by the distance R to the centre of the pneumatic tire 200 in the direction perpendicular to the reference axis 201, identified by the orthogonal projection of this material point on the radial axis 204. The unit vector perpendicular to the radial plane 214, which forms a direct trihedron with the unit vectors of the axial direction 201 and radial direction 204, represents the circumferential direction of the tire casing 100.

This tire 100 has, on the radially inner surface 130, a securing device 10 that is secured to the surface 130 by adhesive bonding according to the usual prior art techniques when the securing device is made of elastomer material. The securing device 10 is secured in line with the crown S of the tire casing 100, and this improves its endurance since the securing device 10 thus positioned invites less concern during the operations of mounting the tire casing 100 on the wheel or removing it therefrom. Specifically, the securing device 10 is situated in a zone remote from the beads B of the tire casing 100. In this case, the securing device 10 is equipped with an electronic member within its open volume that constitutes a housing designed to receive the electronic member. As a result, the tire casing 100 is in this case ready to be mounted on a wheel so as to constitute a mounted assembly. The electronic member may deliver various functions, such as identifying certain components like the electronic member itself, the tire. However, the electronic member may also be equipped with a pressure and/or temperature sensor in order to evaluate the inflation pressure of the mounted assembly. Finally, it may also be equipped with a sensor directly measuring the curvature of the tire casing such as an accelerometer or a flexometer making it possible to derive usual variables of the tire such as the angular speed, the mileage covered, the static load applied. All of these variables make it possible to identify performance qualities of the tire casing such as for example its wear, its grip or intrinsic variables of the ground on which the tire casing runs.

1. A device for securing an electronic member to a wall of a tire casing, comprising:
a base that is able to be secured to the wall of the tire casing via an external surface;
a closed retaining wall, which is able to retain said electronic member, extending from the base as far as a free edge and defining an open volume with said base;
the volume, which is able to accommodate at least a part of said electronic member, being defined by an internal surface of said base and by said retaining wall, having an opening delimited by the free edge of said retaining wall, which is able to deform for the insertion or extraction of said electronic member into or from said volume;
the external surface of said base comprising a homogenous array of recessed elements and protruding elements defining a maximum variation in height of between 10 μm and 200 μm;
wherein, the arrangement of the array of the recessed elements and protruding elements is concentric about a single point of the external surface of the base or in the form of a chequerboard of which the pairwise adjacent tiles are a recessed element and a protruding element.

2. A securing device according to claim 1, wherein the width of the recessed elements between two protruding elements is between 500 μm and 1500 μm.

3. A securing device according to claim 1, wherein the contour of the external surface of the base comprises a protrusion of which the height is less than or equal to the maximum height of the protruding elements of the homogenous array of the external surface of the base.

4. A securing device according to claim 3, wherein the protrusion on the contour of the external surface has a width of less than 500 μm.

5. A securing device according to claim 1, wherein, since the arrangement of the array of the recessed elements and protruding elements is concentric, the voids volume defined by the array is between 30 mm³ and 120 mm³.

6. A securing device according to claim 5, wherein the external surface of the base comprises at least 3 protruding elements.

7. A securing device according to claim 1, wherein, since the arrangement of the array of the recessed elements and protruding elements is in the form of a chequerboard, the voids volume defined by the array is between 1 mm³ and 10 mm³.

8. An arrangement of a tire casing comprising a crown (S), two sidewalls (F) extending from the crown (S) and terminating in two beads (B) that are able to be connected to a wheel, and of a securing device (10) according to claim 1, wherein the securing device is secured to one of the surfaces of the tire casing, preferentially to the wall situated furthest towards the inside of the tire casing.

9. An arrangement according to claim 8, wherein the securing device is secured in line with the crown (S) of the tire casing.

10. An arrangement according to claim 8, wherein the part of the wall situated furthest towards the inside of the tire casing that has to accommodate the securing device comprises an array of recessed elements and protruding elements comprising a maximum variation in height of between 10 μm and 100 μm.

11. An arrangement according to claim 8, wherein the securing device is secured via an adhesive contained in the group comprising cyanoacrylates and silanes.

12. An arrangement according to claim 8, wherein an electronic member is inserted into the securing device of the arrangement.

13. An arrangement according to claim 8, wherein the tire casing of the arrangement is mounted on a wheel, preferentially in an inflated state.
